(19) United States
(12) Patent Application Publication
(10) Pub. No.: US 2018/0343794 A1
(43) Pub. Date: Dec. 6, 2018

(54) ADJUSTABLE FIELD TRIMMER

(71) Applicant: MAT ENGINE TECHNOLOGIES, LLC, Long Grove, IL (US)

(72) Inventors: Edwin Charles SELF, Columbia, TN (US); Jason Dale LEWIS, Huntingdon, TN (US)

(21) Appl. No.: 15/985,375

(22) Filed: May 21, 2018

Related U.S. Application Data
(60) Provisional application No. 62/513,244, filed on May 31, 2017.

(51) Int. Cl. A01D 34/416; A01D 34/68

(52) U.S. Cl. CPC A01D 34/4165; A01D 2101/00; A01D 34/6806

(57) ABSTRACT

An adjustable field trimmer is provided, including a movable, wheeled carriage, a cutting unit pivotally mounted to the carriage and having combined drive system and a cutting head, a power head associated with the cutting unit for powering the cutting head, and a control system associated with the carriage and connected to the cutting unit so that the cutting unit is pivotable laterally relative to the carriage under operator control.

### RELATED APPLICATION

This application claims priority under 35 USC 119 from U.S. Provisional Application Ser. No. 62/513,244, filed May 31, 2017, which is incorporated by reference herein.

### BACKGROUND

The present invention relates generally to lawn mowers, and more particularly to internal combustion-powered mowers used to perform field trimming.

While gasoline-powered lawn mowers are well known, there is a subset of this type of device that is used for field trimming, which relates to trimming grass or plants growing at edges of fields, along fences, sidewalks, buildings, driveways and the like, and around trees. Field trimmers are employed in tracts of land that are not as carefully maintained as traditional lawns, and are usually not mowed as often.

Thus, a field trimmer is employed in environments where a conventional hand-held gasoline-powered trimmer, also referred to as a string trimmer, is considered unsuitable due to lack of cutting power, and/or duration of operation. Conventional field trimmers use a rotating segment of plastic filament, referred to as “string”, which varies in diameter depending on the application, the conventionally available strings being provided in standard diameters.

### SUMMARY

An adjustable field trimmer is provided, featuring a movable, wheeled frame or carriage which contains the power head and a separate forward pivoting frame or cutting unit which contains a combined drive system and a cutting head. The forward frame pivots laterally relative to the carriage under operator control. In the preferred embodiment, the cutting unit is balanced about a pivot point fixed to the carriage so that the operator can readily adjust the unit relative to the carriage without excessive effort. Thus, the present trimmer cutting head is positionable to reach otherwise hard to access locations, such as along fences, yard obstacles such as benches, paths, fountains and the like.

Pivotal movement of the cutting unit is controlled by the operator from a lever and rod linkage preferably located on the carriage, and which is connected to the pivoting cutting unit. From a centered position, the cutting head is movable approximately 3 inches in either the left or right directions, forming an operational arc of 6 inches. The amount of pivoting movement may vary to suit the situation.

In addition, the rotating, stringhead portion of the cutting head, powered by the power unit, is adjustable along a vertical axis to enable cutting at various selected heights. In the preferred embodiment, the heights are respectively, 2-inches, 3-inches and 4-inches from ground level, measured from a ground-contacting surface of the carriage wheels. The heights may vary to suit the application.

Adjustment of the stringhead is achieved by the operator depressing biased clamp buttons on the cutter head housing, which periodically release a pair of clamps holding the housing to an axially oriented driven engagement tube. The engagement tube, which is powered by a belt drive and pulley system connected to the engine or power unit, also mounted on the pivoting cutting head, is indexed to form landing locations for the clamps in each of the desired cutting height settings. In the preferred embodiment, a stringhead housing has a vertical sleeve that telescopingly engages the vertical engagement tube to maintain horizontal alignment of the cutting head. Each clamp button operates a yoke clamp engaging the engagement tube on an opposite side relative to the location of the clamp button.

In an operating position, the clamp buttons are radially outwardly biased so that the clamps tightly engage the engagement tube at the designated height location. To adjust the cutting height, the operator turns off the engine, and depresses both of the clamp buttons, which are preferably located 180° apart from each other. As the clamp buttons are depressed, this action overcomes the biasing force of internal springs that bias the clamps against the engagement tube. When the cutting head is dynamically rotationally energized by the power head, the mass of the clamp yokes guarantee engagement with the engagement tube due to centrifugal forces.

More specifically, an adjustable field trimmer is provided, including a movable, wheeled carriage, a cutting unit pivotally mounted to the carriage and having combined drive system and a cutting head, a power head associated with the cutting unit for powering the cutting head, and a control system associated with the carriage and connected to the cutting unit so that the cutting unit is pivotable laterally relative to the carriage under operator control.

From a centered position, the cutting head is movable approximately 3 inches in either the left or right directions. In addition, a rotating stringhead of the cutting head is adjustable along a vertical axis to enable cutting at various selected heights, respectively, 2-inches, 3-inches and 4-inches from ground level. Adjustment of the stringhead is achieved by the operator depressing biased clamp buttons on the cutter head housing, which periodically release a pair of yoke clamps holding the housing to an axially oriented driven engagement tube.

The engagement tube is provided with vertically spaced notches forming landing locations for the clamps in each of the desired cutting height settings. A pair of diametrically opposed yoke clamps are also provided, each having a lug for engaging a respective one of the notches, and each biased by a biasing element so that the lug is biased against the engagement tube.

In another embodiment, an adjustable field trimmer is provided, including a movable, wheeled carriage, a cutting unit pivotally mounted to the carriage and having combined drive system and a cutting head; and a rotating stringhead of the cutting head is adjustable along a vertical axis to enable cutting at various selected heights.

In still another embodiment, an adjustable field trimmer is provided, including a movable, wheeled carriage, a cutting unit pivotally mounted to the carriage and having combined drive system and a cutting head. A power unit is secured to the cutting unit and is pivotal with the cutting unit. A control system is associated with the carriage and is connected to the cutting unit so that the cutting unit, including the power unit is pivotable laterally relative to the carriage under operator control.

### BRIEF DESCRIPTION OF THE DRAWINGS

FIG. 1 is a top plan view of the present string trimmer, showing the various positions of the cutting unit in phantom;

FIG. 2 is a fragmentary front perspective view of the present cutting head, showing the various cutting heights in phantom;

FIG. 3 is a fragmentary top perspective view of the present string trimmer in a center position;

FIG. 4 is a fragmentary top perspective view of the present string trimmer in a right pivot position;

FIG. 5 is a fragmentary top perspective view of the present string trimmer in a left pivot position;

FIG. 6 is a fragmentary vertical cross-section of the present stringhead;

FIG. 7 is a fragmentary vertical cross-section of the stringhead of FIG. 6 taken at 90 degrees offset from that of FIG. 6;

FIG. 8 is a fragmentary bottom view of the upper stringhead housing in an operational position;

FIG. 9 is a fragmentary bottom view of the stringhead housing of FIG. 8 with one clamp removed and the remaining clamp in the depressed, released position;

FIG. 10 is a fragmentary rear right perspective view of an alternate embodiment of the present field trimmer;

FIG. 11 is a rear perspective view of the field trimmer of FIG. 10 shown in a central position;

FIG. 12 is a fragmentary perspective view of the field trimmer of FIG. 11;

FIG. 13 is a top view of the field trimmer of FIG. 11, shown in the central position;

FIG. 14 is a rear perspective of the field trimmer of FIG. 11 shown in a right position;

FIG. 15 is a fragmentary perspective view of the field trimmer of FIG. 14;

FIG. 16 is a top view of the field trimmer of FIG. 14 shown in the right position;

FIG. 17 is a rear perspective view of the field trimmer of FIG. 11 shown in a left position;

FIG. 18 is a fragmentary perspective view of the field trimmer of FIG. 17; and

FIG. 19 is a top view of the field trimmer of FIG. 17 shown in the left position.

### DETAILED DESCRIPTION

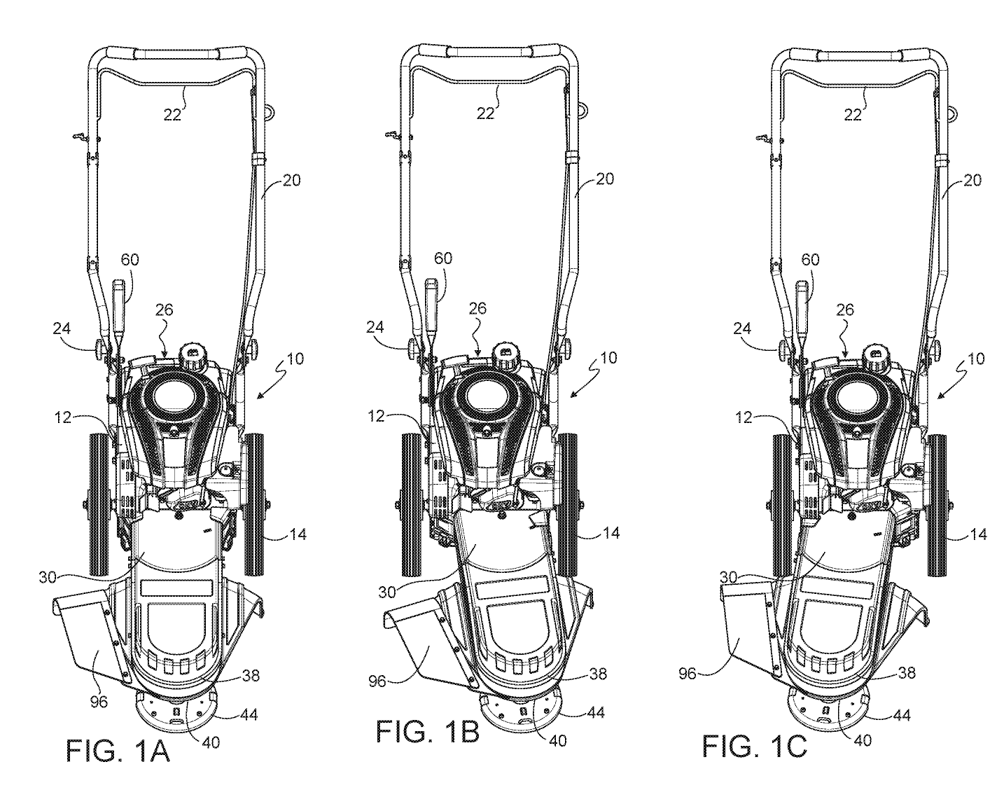

Referring now to FIGS. 1-5, the present field trimmer is generally designated 10, and includes a carriage or frame 12 to which are rotatably mounted a pair of wheels 14. Included on the carriage 12 is a platform 16 to which is secured a pivot point 18, such as a bolt, threaded shaft or the like. As is known in the art, a handle 20 is also secured to the carriage 12, and preferably includes an operator presence control throttle lever 22 which deactivates the power unit once the lever is released, by the operator releasing a grip on the handle and the lever. Also, the handle 20 is preferably pivotable about points 24 for storage, as is known in the art. A power head or power unit 26 is preferably mounted to the platform 16 of the carriage 12. In the preferred embodiment, the power unit 26 is an internal combustion engine, however rechargeable or cord-powered electric motors are also contemplated.

Also included on the field trimmer 10 is a forward frame or cutting unit, generally designated 30, which includes a cutting unit base 32 and a cover 33 with a first or rear end 36. Opposite the first end 36, at a second or front end 38 of the cutting unit base 32 is a cutting head 40. A main feature of the cutting head 40 is a rotating stringhead 42, including a stringhead housing 44 to which is releasably mounted at least one and preferably a pair of conventional trimmer strings 46. A vertically projecting sleeve 48 on the stringhead housing 44 telescopingly engages a depending vertically oriented engagement tube 50.

The engagement tube 50 is axially rotated by the power unit 26 using an endless belt 52 and a pulley assembly 54. A main drive pulley 56 includes a bore 58 that accommodates a driveshaft (not shown) of the power unit 26. As is known in the art, the bore 58 is preferably keyed or noncircular to be complementary to the configuration of the power unit driveshaft to create a positive driving relationship between the power unit 26 and the main drive pulley 56. Thus, the stringhead 42 is ultimately rotated through operation of the power unit 26.

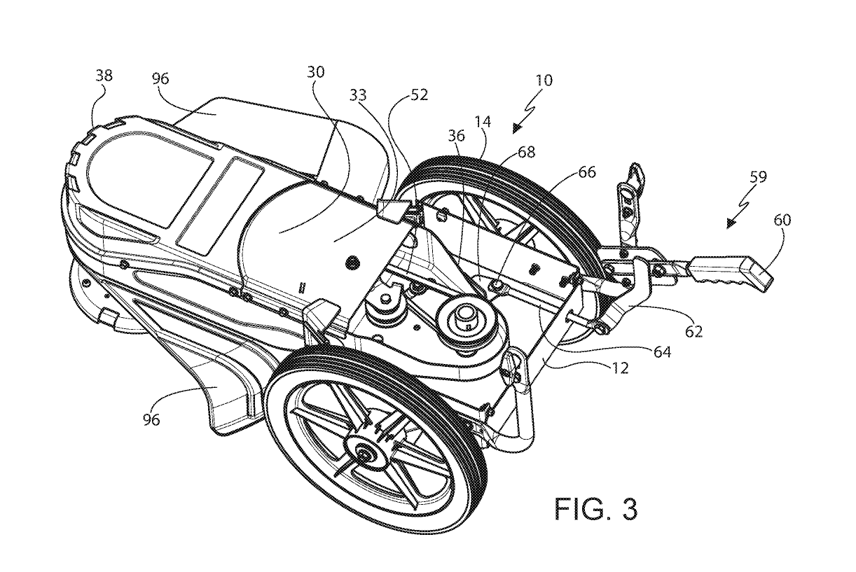

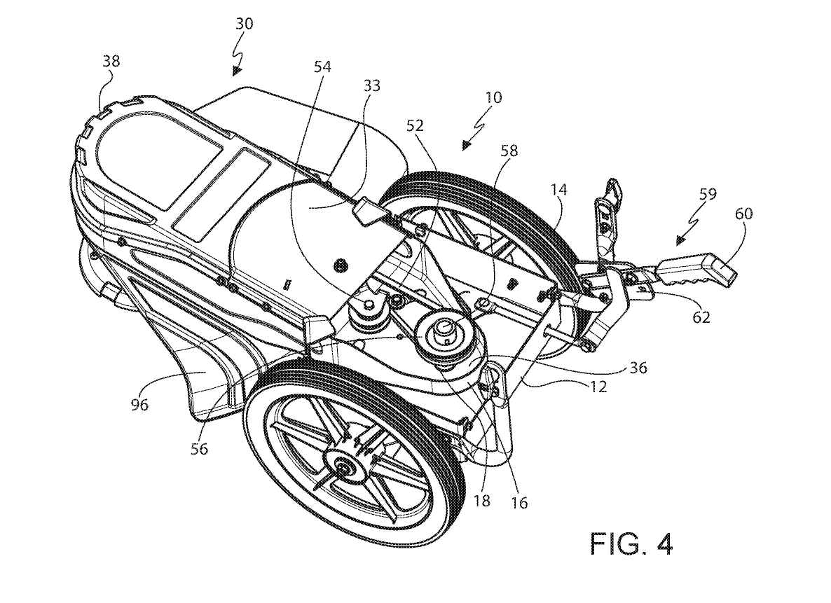

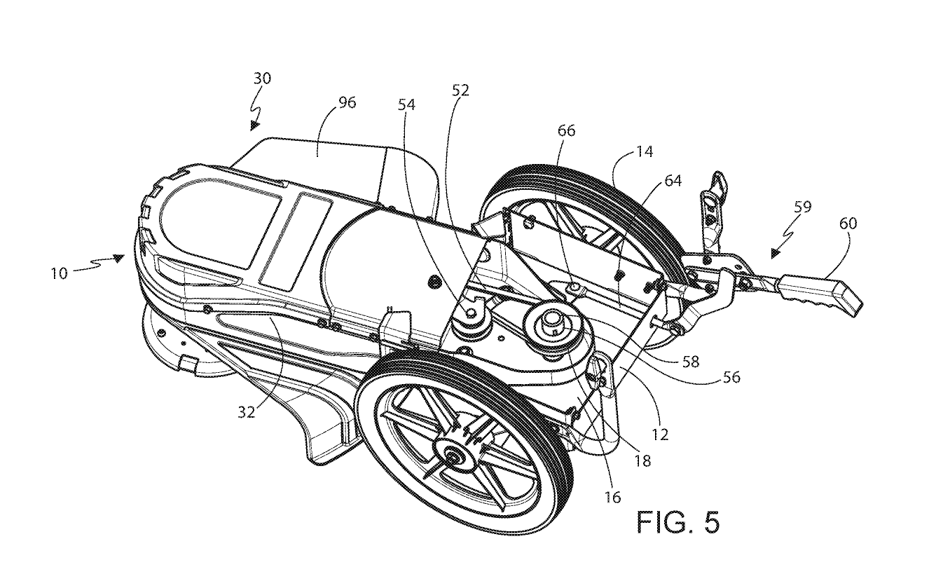

Referring now to FIGS. 3-5, the forward frame or cutting unit 30 is rotated about the pivot point 18 under operator control using a control system 59 including lever handle 60 movable between an upper, center and lower positions relative to the carriage 12. As the lever handle 60 is moved between these positions, a linkage 62 causes a connecting rod 64 to move horizontally forward and backwards relative to the carriage 12. An end 66 of the connecting rod 64 is pivotally connected to the cutting unit 30 through a bracket 68. Thus, as seen in FIG. 4, movement of the rod 64 to a rearward position with the lever handle 60 in an upper position causes the cutting unit 30 to pivot to the right. Similarly, as seen in FIG. 5, movement of the rod 64 to a forward position through movement of the lever handle 60 to a lower position causes the cutting unit 30 to pivot to the left. In FIG. 3, the trimmer 10 is shown with the cutting member 30 in the center position, with the lever handle 60 in an intermediate position.

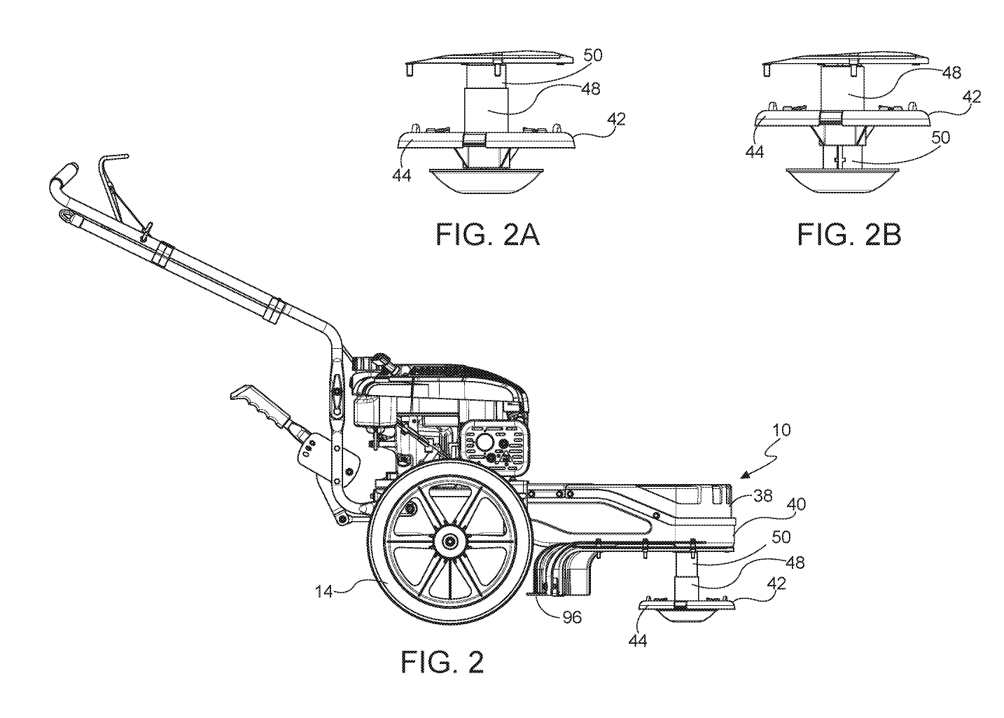

Referring now to FIGS. 2, 6-9, the stringhead housing 44 includes an upper portion 70 with the vertically projecting sleeve 48 that telescopingly engages the engagement tube 50. As seen in FIG. 6, the engagement tube 50 has a vertical slot 74 with vertically spaced transverse notches 76a-c representing respectively the 2, 3, and 4-inch cutting heights of the stringhead. A lug 78 on a yoke clamp 80 engages the desired notch 76a-c as selected by the operator. As seen in FIGS. 6-9, the yoke clamp 80 preferably surrounds the engagement tube 50 and is held in a biased position where the lug 78 is biased into the respective notch 76a-c using a biasing element 82, here a spring wire. Other known types of springs or other biasing elements 82 are contemplated. One end 84 of the biasing element 82 is secured to the upper portion 70, and the opposite, clamp end 86 is clipped or otherwise affixed to a strap 88 of the yoke clamp 80.

A yoke clamp button 90 is formed on the yoke clamp opposite the lug 78 and is actuated by the operator. Depression of the button 90 overcomes the biasing force of the biasing element 82 and releases the engagement of the lug 78 from the notch 76a-c. Once the lug 78 is released, the stringhead 42 is freely slidable along the engagement tube 50 to allow the operator to adjust the cutting height of the stringhead 42. As described above, the preferred cutting heights are 2, 3 and 4-inches relative to the bottom of the wheels 14, however other heights are contemplated.

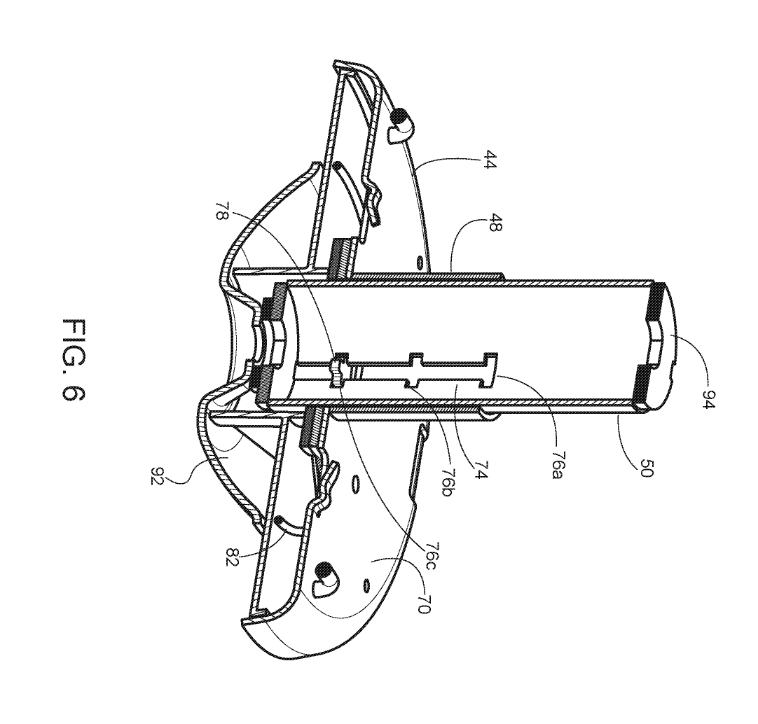

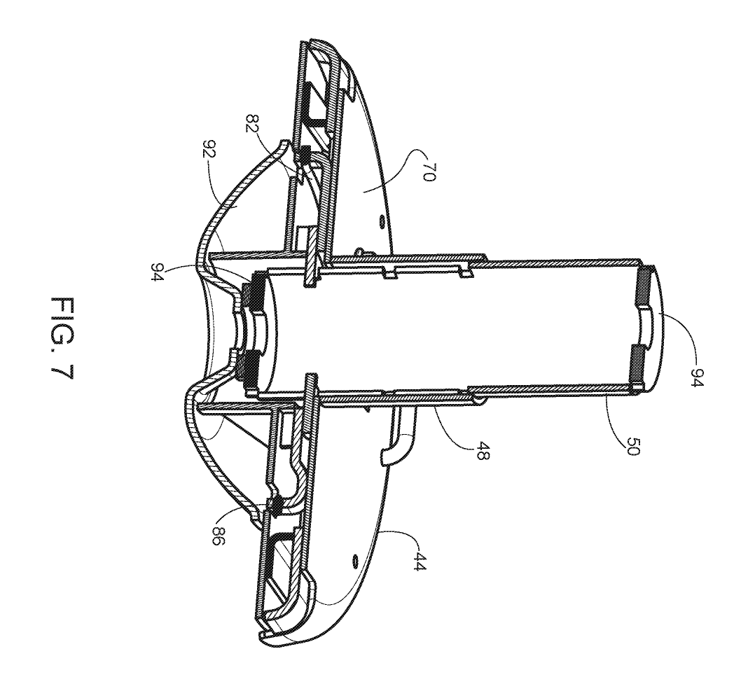

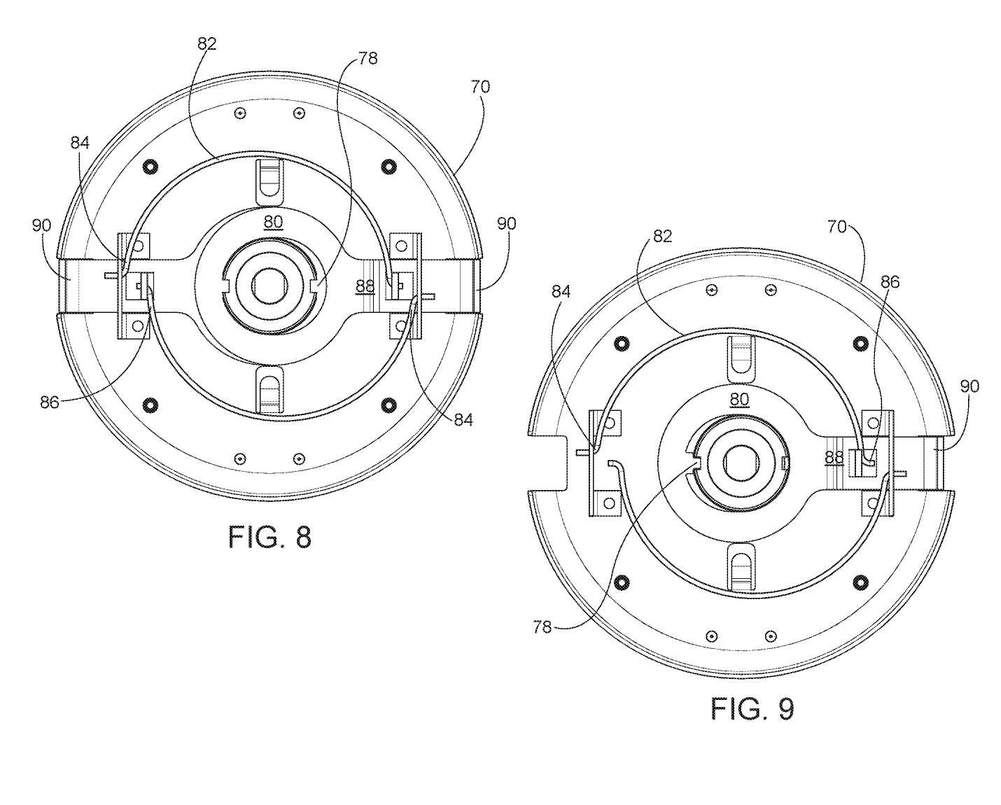

Referring to FIG. 8, it is preferred that two yoke clamps 80 are provided, each engaging an opposite side of the engagement tube 50, and each with a biasing element 82. The construction, shape and diametrically opposed orientation of the yoke clamps 80 are designed for accommodating the significant centrifugal force generated by the rotating engagement tube 50. The biasing elements 82 are relatively weak, and are sufficient for biasing the yoke clamps 80 during operator adjustment, which is also while the power unit 26 is not running However, during the trimming operation, the yoke clamps 80 provide sufficient mass so that as the stringhead 42 spins, the centrifugal force generated on the housing 44 causes the yoke clamps to be urged radially outwardly, or towards the buttons 90, which also acts to maintain engagement of the lugs 78 in the notches 76a-c for maintaining the desired cutting height.

Referring now to FIGS. 6 and 7, a lower portion 92 of the stringhead housing 44 encloses the clamps 80 and the biasing elements 82. Also, it is preferred that the engagement tube 50 is provided with plugs 94 at each end.

Referring again to FIGS. 3-5, the present field trimmer 10 is preferably provided with a shield or guard 96 for protecting the operator from flying clippings or other debris. The guard 96 is mounted to the cutting unit 30 and moves with the above-described pivoting action.

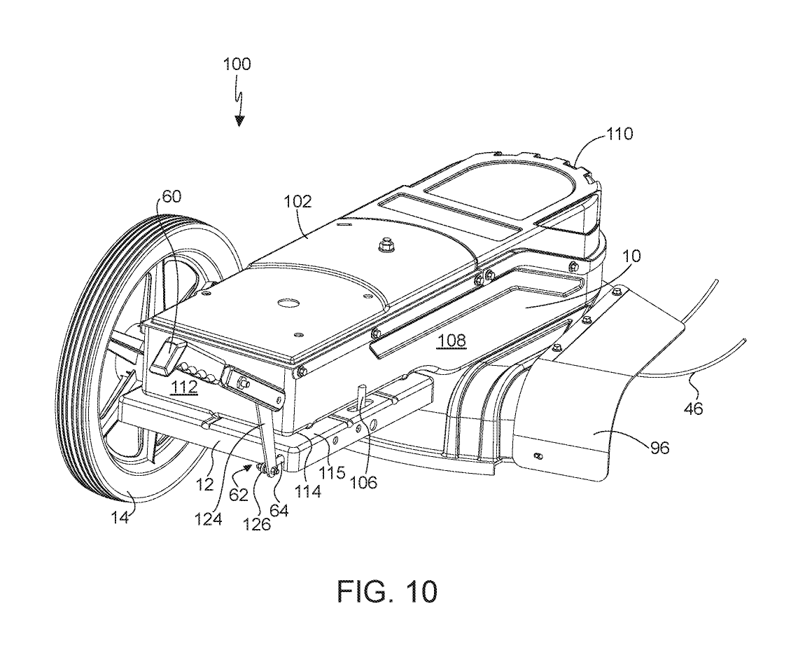

Referring now to FIGS. 10-13, an alternate embodiment of the present trimmer is generally designated 100. Components of the trimmer 100 shared with the trimmer 10 are designated with the same reference numbers. Unless designated otherwise, the two trimmers 10, 100 operate in the same manner and have the same features.

A main difference between the trimmers 10 and 100 is that the latter has the power unit or engine 26 mounted on the cutting unit, now referred to as cutting unit 102, and is pivotable therewith relative to the carriage 12. The pivoting motion, depicted in FIGS. 12, 15 and 18 includes a center position (FIG. 13), a right position (FIG. 16) and a left position (FIG. 19). The engine or power unit 26 has a drive shaft (not shown) that is still drivingly connected to the engagement tube 50 as described above. More specifically, the engine drive shaft is keyed into the bore 58 in the main drive pulley 56.

Also, as seen in FIGS. 3-5 and explained above, the basic pivoting linkage assembly including the handle 60, linkage 62 and connecting rod 64 is the same as in the trimmer 10. As seen in FIGS. 10 and 12, a main distinction in the trimmer 100 is the connection point of the end 66 of the connecting rod 64. In the trimmer 100, the connecting rod end 66 is connected to a depending shaft or rod 106 that is secured, as by welding, fasteners or the like, to a cutting unit housing 108 of the cutting unit 102.

In the trimmer 100, movement of the lever handle 60 between three preset positions causes the cutting unit 102 and the engine or power source 26, to pivot relative to the carriage 12 between the center, right and left positions described above. The cutting unit housing 108 that extends from a front end 110 to a rear end 112 located behind the power source 26. At the rear end 112, the cutting unit housing 108 has a bottom surface 114 that is pivotally movable relative to an upper surface 115 of the carriage 12 via a pivot pin 116, preferably a shoulder bolt or the like, which is supported by a turntable or pivot bearing 118. Since the power source 26 is located almost directly above the carriage 12, the pivot pin 116 and the turntable bearing 118 are sufficient structure for rotatably supporting the pivoting action of the cutting unit 102 relative to the carriage without other support.

Movement of the connecting rod 64 forwards or backwards relative to the direction of travel of the trimmer 100 causes the cutting unit 102 to move between the preselected positions discussed above. The lever handle 60 is mounted on a bracket 120 having three holes 122, each corresponding to one of the three positions of the cutting unit 102. The bracket 120 is secured to the handle 20. In addition, the lever handle 60 has a laterally extending pin (not shown) configured for engaging one of the three holes 122, and is connected to a link arm 124 which in turn is pivotally connected to a rear end 126 of the connecting rod 64 (FIG. 10).

Thus, movement of the lever handle 60 upwards or downwards vertically relative to the bracket 120, so that the lever handle is disengaged from one of the selected holes 122 and engaged in another of the holes, acts through the link arm 116 to move the connecting rod 64 forwards or backwards, thus causing pivoting action of the cutting unit 102, including the engine 26.

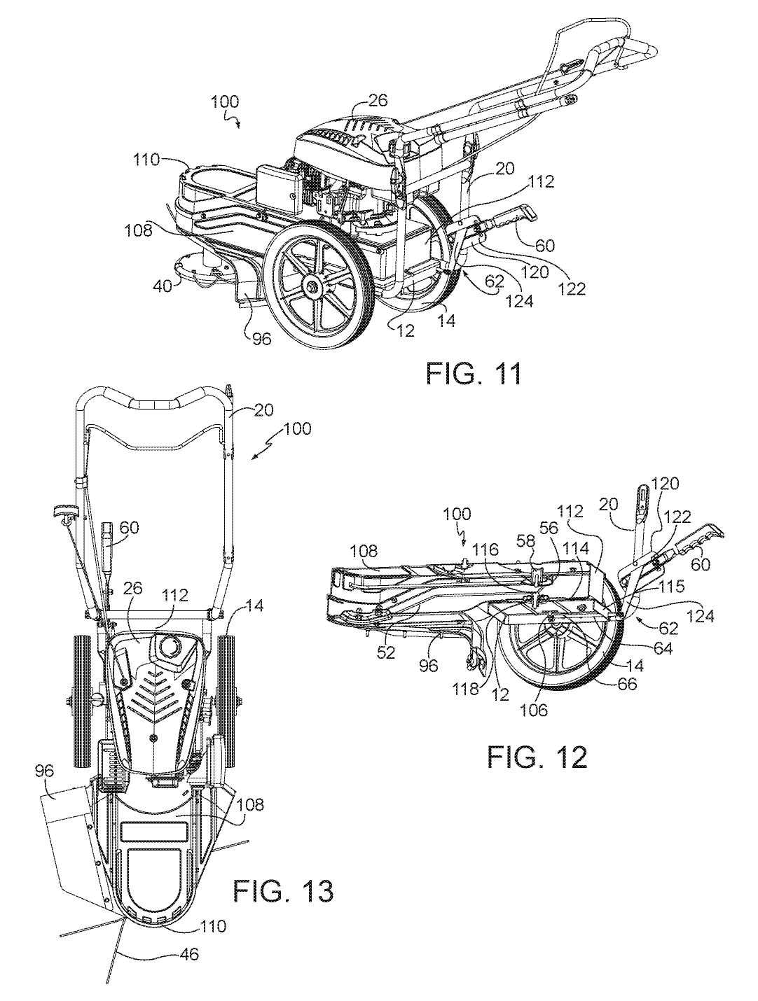

Returning to FIGS. 11-13, the lever handle 60 is located in a center hole 122 in the bracket 120, and the connecting rod 64 is maintaining the depending rod 106 in a central position. As such, the cutting unit 102 is disposed in a central or straight ahead position (FIG. 13).

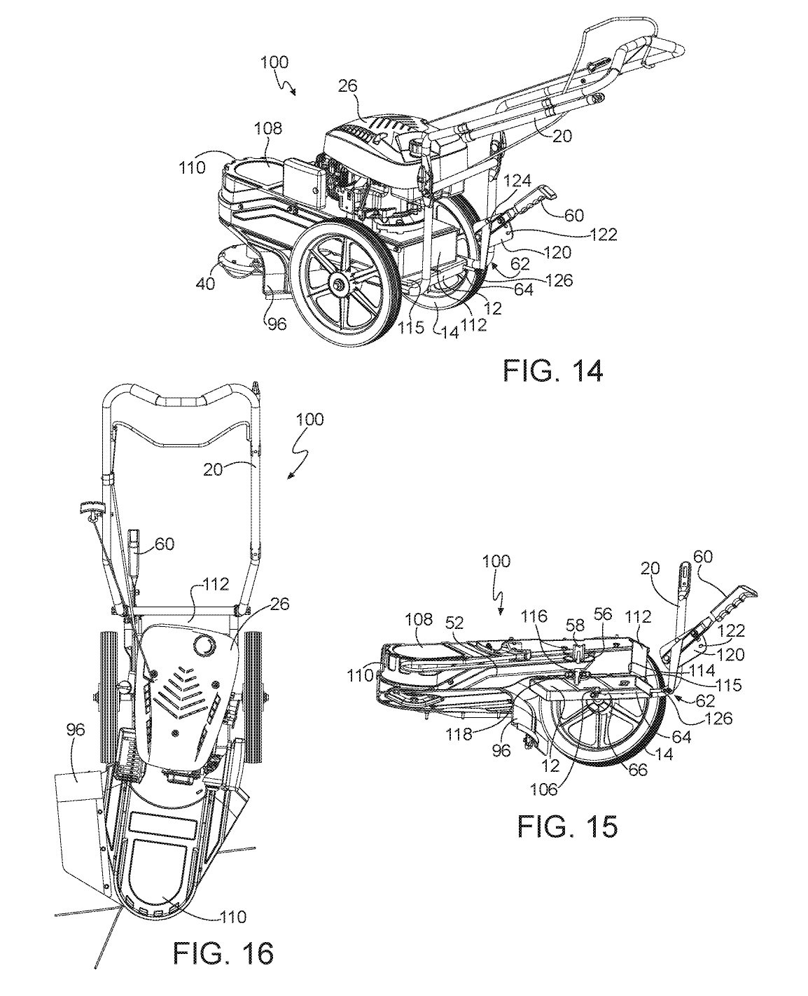

Referring now to FIGS. 14-16, the lever handle 60 has been moved to engage an uppermost hole 122 in the bracket 120, and the connecting rod 64 has been retracted to pull the front end 110 of the cutting unit housing 108 to the right (FIG. 16). The amount of angular deflection from the central or straight ahead position seen in FIG. 13 is in the range of 5 to 15 degrees, which may vary to suit the application.

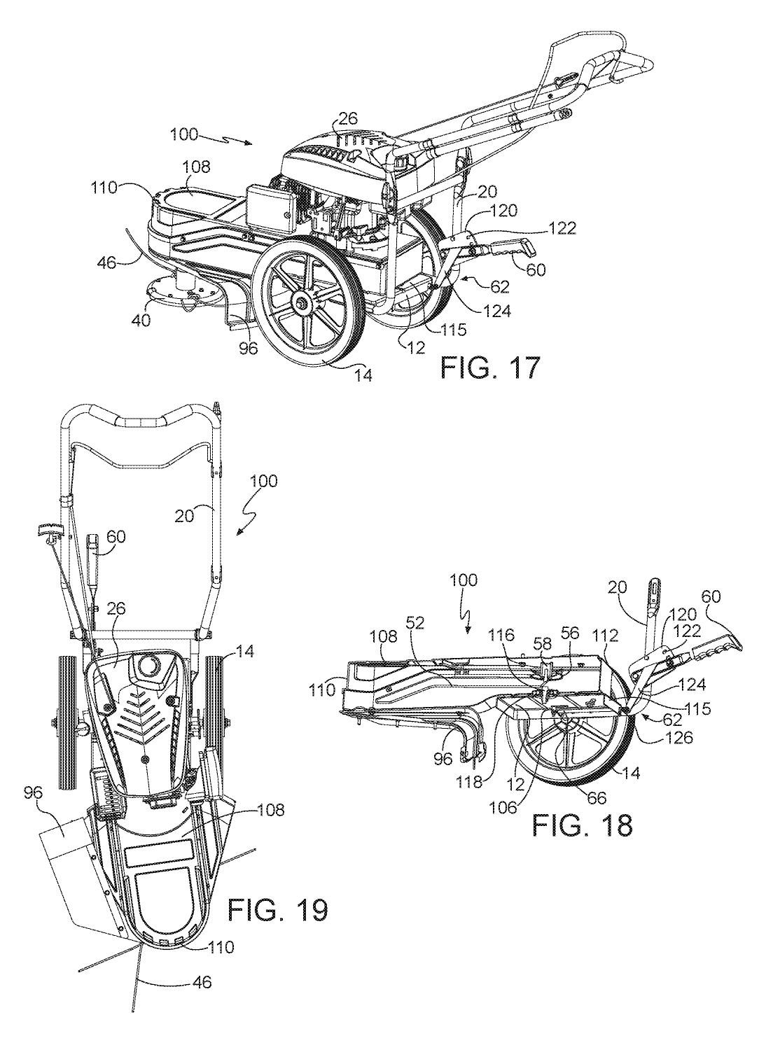

Referring now to FIGS. 17-19, the lever handle 60 has been moved to engage a lowermost hole 122 in the bracket 120. This movement causes the connecting rod 64 to move forward, pushing the front end 110 of the cutting unit housing 108 to the left (FIG. 19). A similar range of deflection is achieved from the center to the right position, and from the center to the left position.

While a particular embodiment of the present adjustable field trimmer has been described herein, it will be appreciated by those skilled in the art that changes and modifications may be made thereto without departing from the invention in its broader aspects and as set forth in the following claims.

1. An adjustable field trimmer is provided, comprising:
a movable, wheeled carriage;
a cutting unit pivotally mounted to the carriage and having combined drive system and a cutting head;
a power head associated with said cutting unit for powering said cutting head; and
a control system associated with said carriage and connected to said cutting unit so that said cutting unit is pivotable laterally relative to said carriage under operator control.

2. The string trimmer of claim 1, wherein from a centered position, said cutting head is movable approximately 3 inches in either the left or right directions.

3. The string trimmer of claim 1, further comprising a rotating stringhead of said cutting head is adjustable along a vertical axis to enable cutting at various selected heights.

4. The string trimmer of claim 3, wherein said cutting heights of said stringhead are respectively, 2-inches, 3-inches and 4-inches from ground level.

5. The string trimmer of claim 3, wherein adjustment of the stringhead is achieved by the operator depressing biased clamp buttons on the cutter head housing, which periodically release a pair of yoke clamps holding the housing to an axially oriented driven engagement tube.

6. The trimmer of claim 5, wherein said engagement tube is provided with vertically spaced notches forming landing locations for the clamps in each of the desired cutting height settings.

7. The trimmer of claim 6, including a pair of diametrically opposed yoke clamps, each having a lug for engaging a respective one of the notches, and each biased by a biasing element so that the lug is biased against the engagement tube.

8. The trimmer of claim 5 wherein a stringhead housing has a vertical sleeve that telescopingly engages said vertical engagement tube to maintain horizontal alignment of the cutting head.

9. The trimmer of claim 7, wherein said yoke clamps are constructed and arranged so that as the stringhead housing rotates, centrifugal force generated by the rotation causes the clamps to be biased so that the lugs are urged into the notches of the engagement tube.

10. An adjustable field trimmer is provided, comprising:
a movable, wheeled carriage;
a cutting unit pivotally mounted to the carriage and having combined drive system and a cutting head; and
a rotating stringhead of said cutting head is adjustable along a vertical axis to enable cutting at various selected heights.

11. The string trimmer of claim 10, wherein said cutting heights of said stringhead are respectively, 2-inches, 3-inches and 4-inches from ground level.

12. The string trimmer of claim 10, wherein adjustment of the stringhead is achieved by the operator depressing biased clamp buttons on the cutter head housing, which periodically release a pair of yoke clamps holding the housing to an axially oriented driven engagement tube.

13. The trimmer of claim 12, wherein said engagement tube is provided with vertically spaced notches forming landing locations for the clamps in each of the desired cutting height settings.

14. The trimmer of claim 13, including a pair of diametrically opposed yoke clamps, each having a lug for engaging a respective one of the notches, and each biased by a biasing element so that the lug is biased against the engagement tube.

15. The trimmer of claim 14, wherein said yoke clamps are constructed and arranged so that as the stringhead housing rotates, centrifugal force generated by the rotation causes the clamps to be biased so that the lugs are urged into the notches of the engagement tube.

16. The trimmer of claim 10, further including a power unit mounted to said carriage and connected to said cutting head for rotating said head.

17. The trimmer of claim 10, further including a power unit mounted to said cutting unit and pivotable with said unit.

18. An adjustable field trimmer is provided, comprising:
a movable, wheeled carriage;
a cutting unit pivotally mounted to the carriage and having combined drive system and a cutting head;
a power unit secured to said cutting unit and being pivotal with said cutting unit; and
a control system associated with said carriage and connected to said cutting unit so that said cutting unit, including said power unit is pivotable laterally relative to said carriage under operator control.
